(19) United States
(12) Patent Application Publication
(10) Pub. No.: US 2015/0055331 A1
(43) Pub. Date: Feb. 26, 2015

(54) LAMP STAND WITH FAUX FLAME

(71) Applicant: Wen-Cheng Lai, Taoyuan Hsien (TW)

(72) Inventor: Wen-Cheng Lai, Taoyuan Hsien (TW)

(21) Appl. No.: 13/974,862

(22) Filed: Aug. 23, 2013

(51) Int. Cl. F21S 10/04; F21V 23/00; F21S 9/00; F21S 6/00

(52) U.S. Cl. CPC F21S 10/046; F21S 6/001; F21V 23/009; F21S 9/00; F21W 2121/00
USPC 362/186; 362/188

(57) ABSTRACT

A lamp stand with faux flame is provided, including a lamp base, a support frame, a flame holder, a flame flake, a light-emitting body and a power supply, wherein power supply disposed inside lamp base; support frame fixedly standing upon lamp base; flame holder fixedly connected to top of support frame and having a vertical via hole; flame flake penetrating via hole and protruding beyond top of flame holder; light-emitting body fixed to flame holder and emitting light towards the direction of flame flake. The light-emitting body is electrically connected to power supply. The lamp stand further includes a motor, an actuator and a pusher. The motor is fixed to lamp base and electrically connected to power supply. The actuator is connected to output of motor. The pusher is disposed on top of actuator. The present invention can replace conventional candle to achieve visual effect of flickering flame.

### FIELD OF THE INVENTION

The present invention generally relates to a lamp technique, and more specifically to a lamp with visual effect of faux flame.

### BACKGROUND OF THE INVENTION

While the traditional candle and oil-lamp are no longer in wide use, the traditional meaning and unique ambience associated with candle and oil lamp are still irreplaceable by the modern light bulb lamp. In particular, in many religious rituals, burning incense, candle or oil lamp is still considered as part of the important auspicious offering for spiritual cleansing. In addition, the flickering flame on the candle stick or oil lamp is considered to have a calming effect to soothe the weariness and fatigue for various occasions. However, as the candle and oil lamp poses potential danger if not carefully handled, the lamps with faux flame are developed. Therefore, many lamps with faux flame are developed to play the conventional role of the candle.

The known lamp with faux flame is usually made into a shape of candle stand, with a flame-shape shade or bulb. A light-emitting body is placed inside the flame-shaped shade or bulb. When supplied with power, the light-emitting body inside the flame-shaped shade or bulb will emit light and the light radiates from the flame-shaped shade or bulb to create a visual effect of the lighted flame. However, as the flame created by the flame-shaped shade or bulb appears fixed, the visual effect is far from satisfactory to emulate the realistic effect of an actual flame.

Thus, it is desirable to devise a lamp with realistic faux flame to replace the actual candle and oil lamp while maintenance realistic visual result.

### SUMMARY OF THE INVENTION

The primary object of the present invention is to provide a lamp with realistic faux flame to replace the actual candle and oil lamp while maintenance realistic visual result.

To achieve the above object, the present invention provides a lamp stand with faux flame, including a lamp base, a support frame, a flame holder, a flame flake, a light-emitting body and a power supply. The power supply is disposed inside the lamp base; the support frame is fixedly standing upon the lamp base; the flame holder is fixedly connected to the top of the support frame and having a vertical via hole; the flame flake penetrates the via hole and protrudes beyond the top of the flame holder; the light-emitting body is fixed to the flame holder and emits light towards the direction of the flame flake. The light-emitting body is electrically connected to the power supply. The lamp stand with faux flame further includes a motor, an actuator and a pusher. The motor is fixed to the lamp base and is electrically connected to the power supply. The actuator is connected to the output end of the motor. The pusher is disposed on top of the actuator. The motor drives the actuator, which in turn drives the pusher to push the flame flake.

Preferably, the pusher includes a pushing stick, which extends upwards. When the pusher pushes the flame flake, the tip of the pushing stick contacts the bottom of the flame flake. The pushing stick can rapidly move away from the flame flake with the pusher so that the pushing stick does not interfering with the swaying of the flame flake.

Preferably, the pusher is made of soft or elastic material. Because the pusher is soft and elastic, a buffering effect can be obtained when pushing the flame flake to avoid strong impact on colliding with the bottom of the flame flake.

Preferably, a coupling axis is disposed horizontally inside the vertical via hole, and the flame flake is disposed with a coupling hole at the center segment so that the coupling axis passes through the coupling hole. As such, the flame flake can rotate around the coupling axis to create realistic visual effect of a flame.

Specifically, the coupling axis has an arc shape or a bend shape. With the arc or bend shape, the center of mass of the coupling axis is lowered so that the flame flake stays in a vertical orientation due to the gravity to provide convenience for the pusher to push.

Preferably, the actuator is a crank, with one end connected to the output end of the motor and the other end fixed to the pusher. By the motor driving the one end of the crank, the other end of the crank can rotate around the axis of the output end of the motor. As such, the pusher can perform circular motion to achieve the object of move towards to away from the bottom of the flame flake.

Preferably, the actuator is a rotational disk, with the center connected to the output end of the motor, the pusher being fixed to the surface edge of the rotational disk and the bottom of the flame flake being above surface edge of the rotational disk. As such, the rotational disk drives the pusher to move in a circular motion so as to change the position of the pusher to achieve the object of move towards to away from the bottom of the flame flake.

Preferably, the lamp stand with faux flame further includes a lamp shade. The lamp shape has an opening at the top. The lamp shade covers on the outside of the lamp base, the support frame and the flame holder. The flame flake passes through the opening and extends beyond the lamp shade. The lamp shade can provide protection to the lamp base, the support frame and the flame holder, as well as additional aesthetic effect to enhance the realistic visual effect of a flame.

Preferably, the lamp stand with faux flame further includes a gearbox, with an input end connected to the output end of the motor and an output end connected to the actuator. The gearbox is to reduce the output rotation speed of the motor so as to adjust the speed of the actuator and the swaying frequency of the flame flake to further enhance the realistic effect.

Compared to known technique, the present invention includes a flame flake hanging in the flame holder and a light-emitting body on the flame holder to emit light towards the flame flake to create a visual effect of flickering flame. With the pusher on the actuator, the motor-driven actuator can move the pusher towards or away from the flame flake. When the pusher contacts the flame flake, the flame flake sways to display a visual effect of flickering flame.

The foregoing and other objects, features, aspects and advantages of the present invention will become better understood from a careful reading of a detailed description provided herein below with appropriate reference to the accompanying drawings.

### BRIEF DESCRIPTION OF THE DRAWINGS

The present invention can be understood in more detail by reading the subsequent detailed description in conjunction with the examples and references made to the accompanying drawings, wherein:

FIG. 1 shows a schematic view of the first embodiment of a lamp stand with faux flame according to the present invention;

FIG. 2 shows a cross-sectional view of a flame holder and a flame flake employed in the first embodiment of the lamp stand with faux flame according to the present invention; and

FIG. 3 shows a schematic view of the second embodiment of the lamp stand with faux flame according to the present invention.

### DETAILED DESCRIPTION OF THE PREFERRED EMBODIMENTS

The following refers to the drawings to describe the preferred embodiments of the present invention.

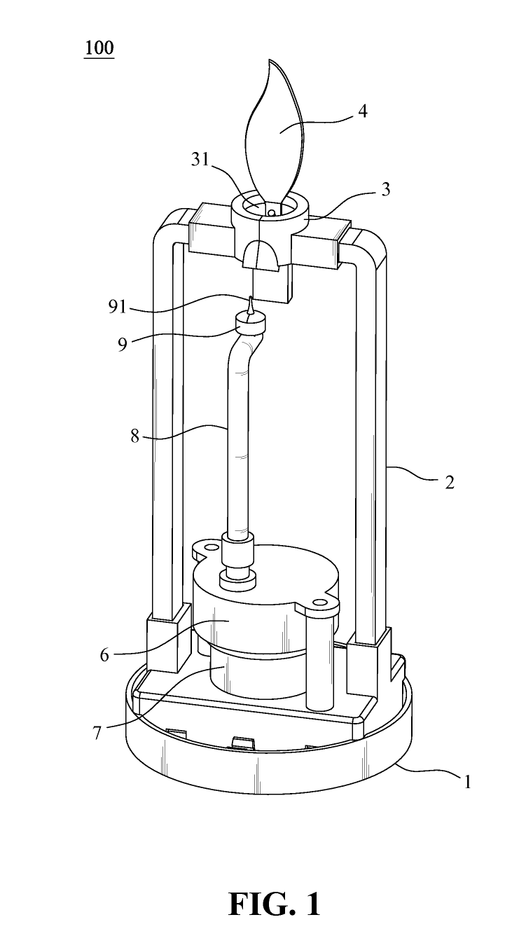

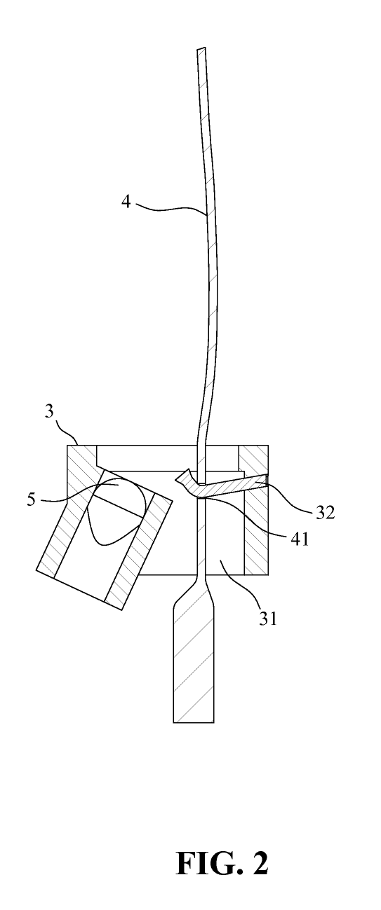

As shown in FIG. 1 and FIG. 2, the first embodiment of a lamp stand with faux flame 1 of the present invention includes: a lamp base 1, a support frame 2, a flame holder 3, a flame flake 4, a light-emitting body 5, a power supply (not shown), a lamp shade (not shown), a gearbox 6, a motor 7, an actuator 8 and a pusher 9. The power supply is disposed inside the lamp base 1; the support frame 2 is fixedly standing upon the lamp base 1; the flame holder 3 is fixedly connected to the top of the support frame 2 and having a vertical via hole 31; the flame flake 4 penetrates the via hole 31 and protrudes beyond the top of the flame holder 3; the light-emitting body 5 is fixed to the flame holder 3 and emits light towards the direction of the flame flake 4. The light-emitting body 5 is electrically connected to the power supply. The motor 7 is fixed to the lamp base 1 and is electrically connected to the power supply, and the output end of the motor 7 is connected to the input end of the gearbox 6. The lower end of the actuator 8 is connected to the input end of the gearbox 6. The pusher 9 is disposed on top of the actuator 8, and is located below the bottom of the flame flake 4. The pusher 9 includes a pushing stick 91, which extends upwards. When the pusher 9 pushes the flame flake 4, the tip of the pushing stick 91 contacts the bottom of the flame flake 4. The pushing stick 91 can rapidly move away from the flame flake 4 with the pusher 9 so that the pushing stick 91 does not interfering with the swaying of the flame flake 4 for extended period of time. The pusher 9 is made of soft or elastic material. Because the pusher 9 is soft and elastic, a buffering effect can be obtained when pushing the flame flake 4 to avoid strong impact on colliding with the bottom of the flame flake 4.

As shown in FIG. 2, specifically, a coupling axis 32 is disposed horizontally inside the vertical via hole 31, and the flame flake 4 is disposed with a coupling hole 41 at the center segment so that the coupling axis 32 passes through the coupling hole 41. As such, the flame flake 4 can rotate around the coupling axis 32 to create realistic visual effect of a flame. The coupling axis 32 is in a plane perpendicular to the direction of pushing by the pusher 9. The coupling axis 32 has an arc shape or a bend shape. With the arc or bend shape, the center of mass of the coupling axis 32 is lowered so that the flame flake 4 stays in a vertical orientation due to the gravity to provide convenience for the pushing stick 91 to push.

As shown in FIG. 1, the actuator 8 is a crank, with one end connected to the output end of the motor 7 and the other end fixed to the pusher 9. By the motor 7 driving the one end of the crank 8, the other end of the crank 8 can rotate around the axis of the output end of the motor 7. As such, the pusher 9 can perform circular motion to achieve the object of move towards to away from the bottom of the flame flake 4.

The actuator 8 in the above embodiment is a crank. However, in another embodiment, the actuator 8 can also be a rotational disk (not shown) of a circular or oval shape, with the center connected to the output end of the gearbox 6. The pusher 9 is fixed to the surface edge of the rotational disk and the bottom of the flame flake 4 is above surface edge of the rotational disk. As such, the rotational disk drives the pusher 9 to move in a circular motion so as to change the position of the pusher 9 to achieve the object of move towards to away from the bottom of the flame flake 4. The actuator 8 can be of other form, such as, swaying flake, which sways through the motor actuation and the swaying motion can also achieve the object of move towards to away from the bottom of the flame flake 4.

The lamp shape has an opening at the top. The lamp shade covers on the outside of the lamp base 1, the support frame 2 and the flame holder 3. The flame flake 4 passes through the opening and extends beyond the lamp shade. The lamp shade can provide protection to the lamp base 1, the support frame 2 and the flame holder 3, as well as additional aesthetic effect to enhance the realistic visual effect of a flame.

In summary of the above description and FIGS. 1 and 2, when the switch of the lamp stand with faux flame is turned on, the light-emitting body 5 emits light onto the flame flake 4. Also, the motor 7 rotates and drives, through the gearbox 6, the crank to move the pusher 9 in a circular motion, which creates an effect of moving towards or away from the bottom of the flame flake 4. When the pusher 9 moves to one side of the bottom of the flame flake 4, the pushing stick 91 of the pusher 9 pushes the flame flake 4 so that the flame flake 4 swings to create a visual effect of flickering flame.

Compared to known technique, the present invention includes a flame flake 4 hanging in the flame holder 3 and a light-emitting body 5 on the flame holder 3 to emit light towards the flame flake 4 to create a visual effect of flickering flame. With the pusher on the actuator 8, the motor-driven actuator 8 can move the pusher 9 towards or away from the flame flake 4. When the pusher 9 contacts the flame flake 4, the flame flake 4 sways to display a visual effect of flickering flame.

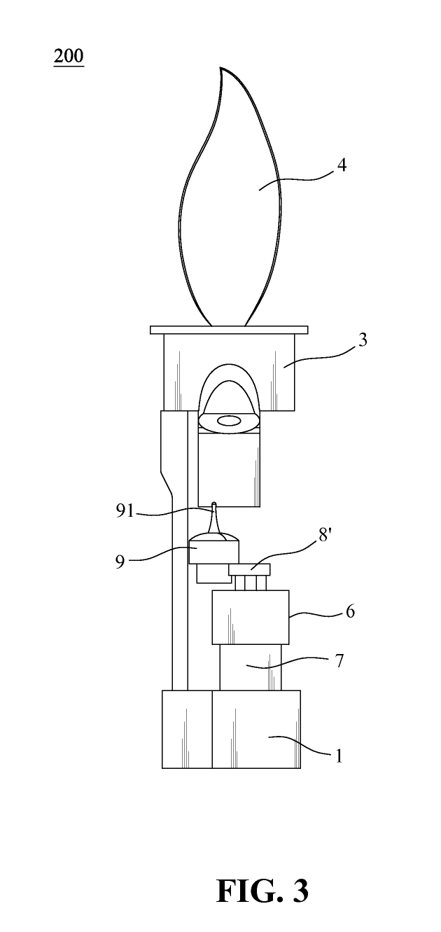

FIG. 3 shows a schematic view of the second embodiment 200 of the lamp stand with faux flame according to the present invention. The second embodiment 200 is generally similar to the first embodiment in structure, except that the second embodiment 200 further includes an actuator 8′ which is a horizontal lever having one end connected operably to an output end of a speed-reduction gear box 6 and the other end fastened to the pusher 9, the achieved effect is the same as the first embodiment so that detailed description thereof is omitted herein for the sake of brevity.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A lamp stand with faux flame, comprising a lamp base, a support frame, a flame holder, a flame flake, a light-emitting body and a power supply; wherein the power supply being disposed inside the lamp base; the support frame being fixedly standing upon the lamp base; the flame holder being fixedly connected to the top of the support frame and having a vertical via hole; the flame flake penetrating the via hole and protruding beyond the top of the flame holder; the light-emitting body being fixed to the flame holder and emitting light towards the direction of the flame flake;
the light-emitting body being electrically connected to the power supply, characterized in that the lamp stand with faux flame further comprising a motor, an actuator and a pusher; wherein the motor being fixed to the lamp base and electrically connected to the power supply; the actuator being connected to the output end of the motor; the pusher being disposed on top of the actuator; the motor driving the actuator, which in turn driving the pusher to push the flame flake.

2. The lamp stand with faux flame as claimed in claim 1, wherein the pusher comprises a pushing stick, extending upwards; when the pusher pushes the flame flake, the tip of the pushing stick contacts the bottom of the flame flake.

3. The lamp stand with faux flame as claimed in claim 1, wherein the pusher is made of soft or elastic material.

4. The lamp stand with faux flame as claimed in claim 1, wherein a coupling axis is disposed inside the via hole, and the flame flake is disposed with a coupling hole at the center segment so that the coupling axis passes through the coupling hole.

5. The lamp stand with faux flame as claimed in claim 4, wherein the coupling axis has an arc shape or a bend shape.

6. The lamp stand with faux flame as claimed in claim 1, wherein the actuator is a crank, with one end connected to the output end of the motor and the other end fixed to the pusher.

7. The lamp stand with faux flame as claimed in claim 1, wherein the actuator is a rotational disk, with the center connected to the output end of the motor, the pusher being fixed to the surface edge of the rotational disk and the bottom of the flame flake being above surface edge of the rotational disk.

8. The lamp stand with faux flame as claimed in claim 1, further comprising a lamp shade; wherein the lamp shape having an opening at the top; the lamp shade covering on the outside of the lamp base, the support frame and the flame holder; and the flame flake passing through the opening and extending beyond the lamp shade.

9. The lamp stand with faux flame as claimed in claim 1, further comprising: a gearbox, with an input end connected to the output end of the motor and an output end connected to the actuator.
